(19) United States
(12) Patent Application Publication
(10) Pub. No.: US 2023/0368060 A1
(43) Pub. Date: Nov. 16, 2023

(54) SYSTEMS AND METHODS FOR IMPLEMENTING REMOTE-STATE PREPARATION ON A NOISY-INTERMEDIATE SIZE QUANTUM DEVICE

(71) Applicant: Laura Lewis, Chester Springs, PA (US)

(72) Inventor: Laura Lewis, Chester Springs, PA (US)

(21) Appl. No.: 17/900,973

(22) Filed: Sep. 1, 2022

Related U.S. Application Data
(60) Provisional application No. 63/239,383, filed on Aug. 31, 2021.

(51) Int. Cl. G06N 10/40; G06F 17/16

(52) U.S. Cl. CPC G06N 10/40; G06F 17/16

(57) ABSTRACT

A protocol is implemented for remotely preparing quantum states, with application to blind and verifiable delegated quantum computation. A remote-state preparation protocol relies on the use of cryptographic primitives known as Noisy Trapdoor Claw-Free (NTCF) functions. The NTCF functions are based on conjectured post-quantum secure problems. The NTCF functions are evaluated in superposition on a Noisy-Intermediate Size Quantum (NISQ) device. Thereby, the potential of NISQ devices for cryptographic applications is assessed.

### CROSS-REFERENCE TO RELATED APPLICATIONS

This application claims the benefit of U.S. Provisional 63/239,383, filed Aug. 31, 2021, which is hereby incorporated by reference as submitted in its entirety.

### FIELD OF THE INVENTION

The present invention relates to an implementation of a protocol for remotely preparing quantum states and, more specifically, a remote-state preparation protocol that uses cryptographic primitives.

### BACKGROUND

A Noisy Intermediate-Size Quantum (NISQ) device is a quantum computer having a relatively small number of qubits (on the order of 100) and whose gates are subject to noise. This means that every time a quantum operation is performed, there is some probability that an error is introduced into the computation. While it is expected that the detrimental effects of this noise can be mitigated using quantum error correcting codes and protocols for fault-tolerant quantum computation, such protocols generally require large numbers of qubits and so are not suitable for current and near-term devices. A recent demonstration of quantum computational supremacy showed that it is possible to obtain computational advantages from using NISQ devices. One challenge in using NISQ devices is verifying the results they produce. In other words, how can classical users that delegate computations to these NISQ devices efficiently check that the results they obtained are correct?

This question is partially answered by recent works that have proposed protocols for certifiable randomness generation, remote-state preparation, self-testing of a single quantum device and verification of general quantum computation. All these protocols make use of a cryptographic primitive known as Noisy Trapdoor Claw-Free (NTCF) functions. A trapdoor function is a type of one-way function (a function that is easy to evaluate but hard to invert), that can be efficiently inverted given a secret key known as a trapdoor. A pair of functions β₁, ƒ₂ is claw-free if there is no efficient algorithm to find two input x₁, x₂ that satisfy the equality ƒ₁(x₁)=ƒ₂(x₂). Thus, a trapdoor claw-free function satisfies both properties.

Currently, protocols regarding certifiable randomness generation, remote-state preparation, self-testing of a single quantum device and verification of general quantum computation assume that the quantum device can evaluate an NTFC function coherently (i.e. in superposition). However, this cannot be achieved perfectly on a NISQ device because of the errors incurred when performing quantum operations.

A remote-state preparation protocol was developed for verifiable delegated quantum computation, using only classical communication. Delegated quantum computation is a problem where a classical user has a description of a quantum circuit C, and wants to delegate the evaluation of C|00 . . . 0> to a quantum computer. Importantly, the user wants to be able to efficiently verify that the quantum computer performed this computation correctly. In this setting, the user is typically referred to as the verifier, whereas the quantum server is the prover. While this scheme was the first such protocol to utilize only classical communication between the verifier and prover, one disadvantage is that in order to delegate a quantum state comprising of poly(G)-many qubits. In addition, this protocol, referred to as Mahedev's protocol, does not achieve a cryptographic property known as blindness. Roughly speaking, blindness means that the quantum circuit C is not revealed to the power throughout the protocol.

To address these limitations, the remote-state preparation protocol was developed and showed how it can be used to achieve blind and verifiable delegated quantum computation (using only classical communication). This protocol has two stages. First, the verifier delegates to the prover the preparation of certain single-qubit quantum states and checks that these states were prepared correctly. This is the RSP sub-protocol, for example. Then, the verifier instructs the prover to perform a general quantum computation by suitably entangling and measuring these states according to the protocol. The fact that the protocol can be separated into the state preparation phase and the delegated computation phase is in contrast to Mahadev's protocol which has a more monolithic structure. RSP thus provides a way to “dequantize” quantum communication from quantum protocols.

Therefore, there currently exists a need to implement a protocol for remotely preparing quantum states, with applications to blind and verifiable delegated quantum computation. Further, there exists a need to investigate cryptographic applications of NISQ devices, and specifically the feasibility of evaluating claw-free functions on these devices. A few companies (e.g., Google®, IBM® and Rigetti®) develop NISQ devices which have been made available to users on the Internet through cloud services. It is therefore not only important to have NISQ applications but also to have ways of verifying the results for these applications.

### BRIEF SUMMARY OF THE INVENTION

The present embodiments may relate to, inter alia, systems and methods for delegating and verifying the preparation of quantum states on Noise Intermediate-Size Quantum (NISQ) devices. A NISQ device, for example, is a quantum computing device having a relatively small number of qubits and whose gates are subject to noise. In some embodiments, a protocol may be implemented for remotely preparing quantum states. Additionally, one or more applications may be implemented to perform verifiable delegated quantum computation. Further, the protocol may rely on the use of cryptographic primitives or functions. The functions may be based on conjectured post-quantum secure problems, for example.

### BRIEF DESCRIPTION OF THE DRAWINGS

This disclosure is illustrated by way of example and not by way of limitation in the accompanying Figures. The Figures may, alone or in combination, illustrate one or more embodiments of the disclosure. Elements illustrated in the Figures are not necessarily drawn to scale. Reference labels may be repeated among the Figures to indicate corresponding or analogous elements.

FIG. 1 illustrates an exemplary Noisy-Intermediate-Size Quantum (NISQ) computing system in accordance with an exemplary embodiment of the present disclosure.

FIG. 2 illustrates an exemplary client computing device that may be used with the NISQ computing system illustrated in FIG. 1.

FIG. 3 illustrates an exemplary server system that may be used with the NISQ computing system illustrated in FIG. 1.

FIG. 4 illustrates an exemplary evaluation of a Noisy Trapdoor Claw-Free (NTCF) function circuit diagram in accordance with at least one embodiment of the disclosure.

FIG. 5 illustrates an exemplary graph of optimized performance of a circuit in accordance with at least one embodiment of the disclosure.

FIG. 6A and FIG. 6B illustrate plots of uniform distribution in accordance with at least one embodiment of the disclosure.

FIG. 7A and FIG. 7B illustrate plots of binomial distribution in accordance with at least one embodiment of the disclosure.

FIG. 8A and FIG. 8B illustrate plots of multinomials distribution in accordance with at least one embodiment of the disclosure.

FIG. 9 illustrates an exemplary circuit to phase encode two bits in accordance with at least one embodiment of the disclosure.

FIG. 10 illustrates an exemplary circuit to phase encode three bits in accordance with at least one embodiment of the disclosure.

FIG. 11 illustrates an exemplary visualization of states in XY plane of Bloch Sphere in accordance with at least one embodiment of the disclosure.

The FIGURES depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The FIGURES and descriptions provided herein may have been simplified to illustrate aspects that are relevant for a clear understanding of the herein described apparatuses and methods, while eliminating, for the purpose of clarity, other aspects that may be found in typical similar apparatus and methods. Those of ordinary skill may thus recognize that other elements and/or operations may be desirable and/or necessary to create apparatuses and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

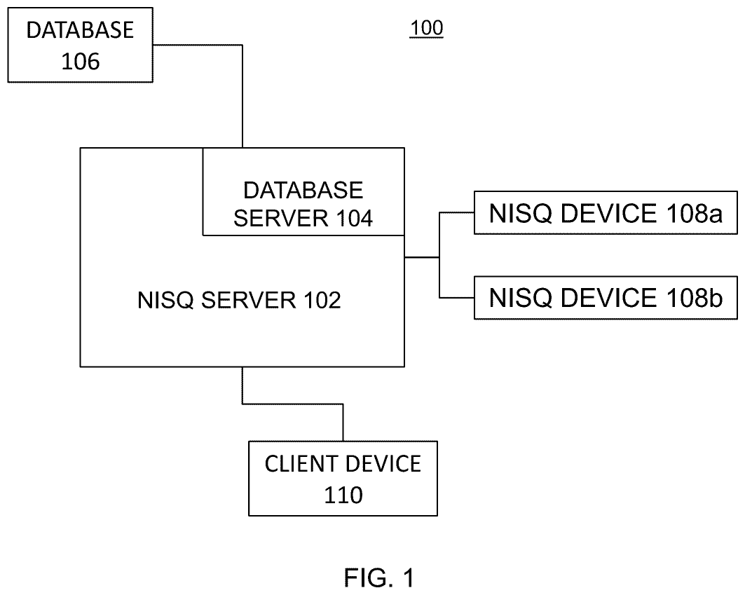

FIG. 1 depicts a simplified block diagram of an exemplary computing system 100. In the exemplary embodiment, system 100 may be used for implementing remote-state preparation (RSP) on a noisy-intermediate size quantum (NISQ) device, such as the NISQ server 102 shown and described in FIG. 1. The NISQ server 102 may be in communication with one or more databases (or other memory devices) 106, client device 110, and/or NISQ devices 108a and 108b.

In the exemplary embodiment, client device 110 and NISQ devices 108a and 108b may be computers that include a web browser or a software application, which enables the devices to access remote computer devices. In one example, client device 110 may access and retrieve data pertaining to NISQ devices 108a and 108b for the implementation of protocols for remotely preparing quantum states.

Client device 110 and NISQ devices 108a and 108b may be communicatively coupled to NISQ server 102 through many interfaces including, but not limited to, at least one of the Internet, a network, such as the Internet, a local area network (LAN), a wide area network (WAN), or an integrated services digital network (ISDN), a dial-up connection, a digital subscriber line (DSL), a cellular phone connection, and a cable modem. Client device 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, client device 110 may transmit data to NISQ server 102 (e.g., user data, media content, computer instructions, etc.).

A database server 104 is communicatively coupled to a database 106 that stores data. In one embodiment, database 106 may include, but is not limited to, quantum computing data, error data, protocol data, evaluation data, implementation data, or the like. In the exemplary embodiment, database 106 is stored remotely from NISQ server 104. In some embodiments, database 106 is decentralized. In the exemplary embodiment, a user may access database 106 via a user computer device, such as client device 110 by logging onto NISQ server 102, as described herein.

NISQ server 102 may be in communication with a plurality of NISQ devices 108. More specifically, NISQ server 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. NISQ server 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, NISQ server 102 is also associated with a plurality of user computer devices (not shown) that allow individual users to access NISQ server 102 and database 106. In some embodiments, NISQ server 102 comprises a plurality of computer devices working in concert.

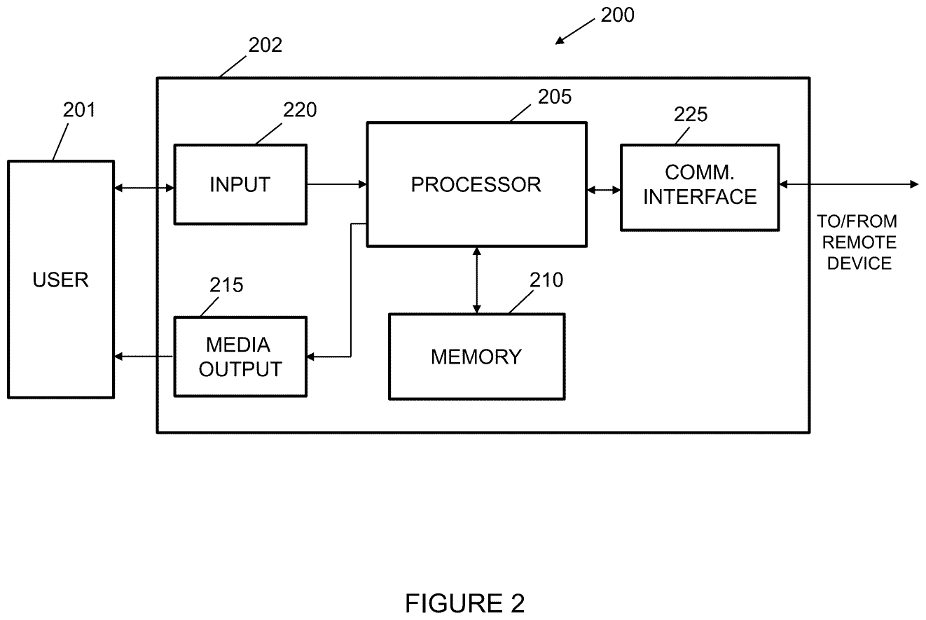

FIG. 2 depicts an exemplary configuration 200 of a user, or client, computer device, in accordance with one embodiment of the present disclosure. User computer device 202 may be operated by a user 201. User computer device 202 may include, but is not limited to, client device 110 or NISQ devices 108a and 108b (both shown in FIG. 1). User computer device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or transaction data to be stored and retrieved. Memory area 210 may include one or more computer readable media.

User computer device 202 may also include at least one media output component 215 for presenting information to user 201. Media output component 215 may be any component capable of conveying information to user 201. In some embodiments, media output component 215 may include an output adapter (not shown) such as a video adapter and/or an audio adapter. An output adapter may be operatively coupled to processor 205 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 215 may be conFig.d to present a graphical user interface (e.g., a web browser and/or a client application) to user 201. A graphical user interface may include, for example, an interface for viewing and evaluating performance data. In some embodiments, user computer device 202 may include an input device 220 for receiving input from user 201. User 201 may use input device 220 to, without limitation, update, or revise protocol implementation data.

Input device 220 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 215 and input device 220.

User computer device 202 may also include a communication interface 225, communicatively coupled to a remote device such as NISQ server 102 (shown in FIG. 1). Communication interface 225 may include, for example, a wired or wireless network adapter and/or a wireless data transceiver for use with a mobile telecommunications network.

Stored in memory area 210 are, for example, computer readable instructions for providing a user interface to user 201 via media output component 215 and, optionally, receiving and processing input from input device 220. A user interface may include, among other possibilities, a web browser and/or a client application. Web browsers enable users, such as user 201, to display and interact with media and other information typically embedded on a web page or a website from NISQ server 102. A client application may allow user 201 to interact with, for example, NISQ server 102. For example, instructions may be stored by a cloud service, and the output of the execution of the instructions sent to the media output component 215.

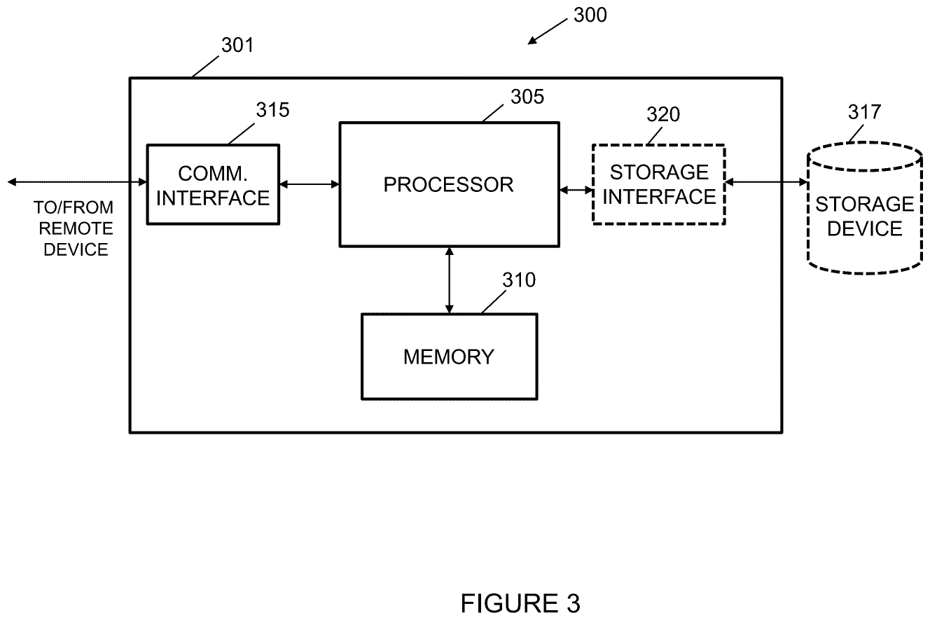

FIG. 3 depicts an exemplary configuration of server system 300, in accordance with one embodiment of the present disclosure. Server computer device 301 may include, but is not limited to, NISQ server 102 or database server 104 (all shown in FIG. 1). Server computer device 301 may also include a processor 305 for executing instructions. Instructions may be stored in a memory area 310. Processor 305 may include one or more processing units (e.g., in a multi-core configuration).

Processor 305 may be operatively coupled to a communication interface 315 such that server computer device 301 is capable of communicating with a remote device such as another server computer device 401, NISQ server 102, or the like (for example, using wireless communication or data transmission over one or more radio links or digital communication channels). For example, communication interface 315 may receive evaluation data from client device 110 or performance data from NISQ devices 108a or 108b via the Internet.

Processor 305 may also be operatively coupled to a storage device 317. Storage device 317 may be any computer-operated hardware suitable for storing and/or retrieving data, such as, but not limited to, data associated with database 106 (shown in FIG. 1). In some embodiments, storage device 317 may be integrated in server computer device 301. For example, server computer device 301 may include one or more hard disk drives as storage device 317.

In other embodiments, storage device 317 may be external to server computer device 301 and may be accessed by a plurality of server computer devices 301. For example, storage device 317 may include a storage area network (SAN), a network attached storage (NAS) system, and/or multiple storage units such as hard disks and/or solid state disks in a redundant array of inexpensive disks (RAID) configuration.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Processor 305 may execute computer-executable instructions for implementing aspects of the disclosure. In some embodiments, the processor 305 may be transformed into a special purpose microprocessor by executing computer-executable instructions or by otherwise being programmed. For example, the processor 305 may be programmed with the instructions.

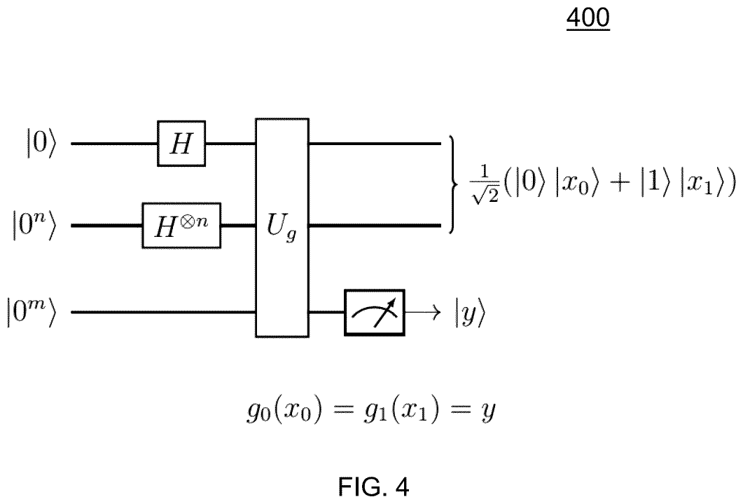

In some embodiments, as depicted in diagram 400 of FIG. 4, a portion of the remote-state preparation (RSP) protocol implements the evaluation of NTCF functions as well as a measurement to create a convenient state for the rest of the protocol.

In this example, the first register is the b input to g(b,x) and the second register is the x input. Furthermore, the unitary operation U_{g} is the operation to evaluate the function on the first two registers, which is then stored in the third register. After evaluating the function in superposition, the result of the computation is measured (i.e., the third register, to obtain an image of the function y. The measurement collapses the first two registers to the state specified in FIG. 4, then information is obtained about the preimages of g(b,x)=y from this state. This information about the preimages is then used to test for verifiability of the protocol. In some embodiments, the implemented circuit may be a part of the RSP protocol, which then has the previously mentioned applications.

Specifically, there are two tests for verifiability: the preimage test and equation test. Following the preparation of the state

$$\frac{1}{\sqrt{2}} ( \vert 0 〉 \vert {x}_{1} 〉 + \vert 1 〉 \vert {x}_{2} 〉$$

according to the circuit 400 of FIG. 4, the preimage test requests for the prover to measure this state in the computational basis to obtain b, x. Then, the verifier can check that g(b, x)=y, and if this is satisfied, the test is passed. On the other hand, the equation test requests a string d, obtained by measuring the collapsed preimage state in the Hadamard basis. In this case, the verifier checks that

d·(x₁⊕x₂)=b

using the trapdoor from g to compute both preimages x₁, x₂. Satisfying this condition is known as the prover generating a valid equation. In both applications of certifiable randomness and remote state preparation, each of these tests are performed with equal probability. In some embodiments, success may be measured as the probability that the prover passes the equation check.

Systems and methods are provided to investigate cryptographic applications of NISQ devices, and specifically the feasibility of evaluating claw-free functions on these devices. In some embodiments, techniques may be used to implement the remote-state preparation protocol. Additionally, or alternatively, optimizations may be made to reduce the number of qubits required as well as the depth of the circuit.

The systems and methods described herein facilitate a high level implementation of the evaluation of an NTCF function which is decomposed into elementary operations. Additionally, a performance analysis of the implementation may be provided of the implementation for small instances. For example, performance analysis may be quantified with the Hellinger overlap. In an alternative embodiment, implementation may include an approach influenced by the problem Learning with Rounding (LWR) as well as Learning with Errors (LWE). Further, optimizing the LWR approach may be provided with analysis of several techniques for reducing qubit usage and depth.

In some implementations, the following equation may be used:

g(b,x)=Ax+b·(As+e′)+e(mod q)

where

b∈{0,1},A∈ [symbol] _{q}^{m×n},x∈ [symbol] _{q}ⁿ,s∈{0,1}ⁿ,e′∈ [symbol] _{q}^{m}, and e∈ [symbol] ^{m} (1)

The evaluation of this function in superposition involves only matrix-vector operations, which can be efficiently parallelized and performed in depth that is logarithmic with respect to the size of the input. In an example implementation, Microsoft's Q #quantum programming language may be used. The Q #has built-in operations for modular arithmetic operations. For example, in the code block below, MultiplyAndAddByModularinteger and IncrementByModularInteger, are such operations included in Microsoft's Quantum Development Kit for performing modular arithmetic in quantum registers.

| | |
|---|---|
| 27 | // add quantum registers x and y into y, mod modulus |
| 28 | operation addRegisters (x : Qubit[ ], y : Qubit[ ], c : Int, modulus : |
| | Int) : Unit is Adj + Ctl { |
| [symbol] | MultiplyAndAddByModularInteger(c, modulus, LittleEndian(x), |
| | LittleEndian(y)); |
| 30 | } |
| 31 | |
| 32 | // add constant int to register res. mod modulus |
| 33 | operation addConstantToRegister (c : Int, modulus : Int, res : Qubit |
| | [ ]) : Unit is Adj + Ctl { |
| 34 | IncrementByModularInteger(c, modulus, LittleEndian(res)); |
| 35 | } |

[symbol]

indicates data missing or illegible when filed

In this example, MultiplyAndAddByModularinteger and

IncrementByModularInteger implement the transformations:

|x [symbol] |y [symbol] →|x [symbol] |(CX+y) mod N

[symbol]

|x [symbol] →|(x+c) mod N

[symbol]

respectively, for some constant c and modulus N. The functions may be wrapped in addRegisters and addConstantToRegister, for example. The functions may be wrapped foor implementing the evaluation of the function in Equation 1.

In this example, take As+e′ and A itself classically, and have

|b [symbol] |x [symbol] |e

[symbol]

then Ax+e may be computed by MultiplyAndAddByModularinteger to compute the inner product between each row of A and x and add this result to the e register. Moreover, b·(As+e′) can be added in by utilizing a controlled version of addConstantToRegister.

Systems and methods disclosed herein provide for the decomposition of high level operations. Despite the convenience of utilizing Q #'s built-in functionality as seen in the previous section, these operations act as a black box, and the documentation for them is not explicitly available to analyze what the operations are actually executing in terms of elementary gates. However, because NISQ devices introduce noise for each quantum operation, a circuit is provided to have optimal depth. For example, an implementation that requires as few quantum operations as possible will result in less noise in the output of the protocol. Hence, high level operations are decomposed into circuits composed of rotation gates and quantum fourier transforms (QFT). In some embodiments, MultiplyAndAddByModularinteger and IncrementByModularInteger correspond to the controlled multiplier gate and modular adder gate, respectively.

An example of one such decomposed operation can be seen in the code block below. Note that the version in the code block implements the transformation

|x [symbol] →|(x+c) mod N

[symbol]

only for N=2ⁿ, where n is the size of the register that the constant is being added into.

In this example, the general modulus version is much more involved. In some embodiments, the operation corresponds to a for decomposing the operation IncrementByModularInteger into single qubit rotations using R1Frac as well as the QFT with QFTLE.

### Example Operation

| [symbol] | // maps \|x> to \|x + c (mod modulus)> |
|---|---|
| [symbol] | // this version only works if modulus = 2⁻n, where n = |
| | Length(x) = Length(y) |
| [symbol] | operation addConstantToRegister(c : Int, modulus : Int, res : |
| | (Qubit[ ]) : Unit is Adj + Ctl { |
| [symbol] | body (...) { |
| [symbol] | let n = Length(res); |
| [symbol] | QFTLE(LittleEndian(res)); |
| [symbol] | for (i in 0 .. n − 1) { |
| [symbol] | R1Frac(c, (n − 1) − i, (res)[i]); |
| [symbol] | } |
| [symbol] | Adjoint QFTLE(LittleEndian(res)); |
| [symbol] | } |
| [symbol] | adjoint invert; |
| [symbol] | controlled distribute; |
| [symbol] | controlled adjoint distribute; |
| 8 [symbol] | } |

[symbol]

indicates data missing or illegible when filed

In some embodiments, QFT may be implemented (also referred to as QFTNormal), as displayed below. This implementation is based off of that given in the Qiskit documentation as well as a circuit known for the QFT. Note that in the Qiskit documentation, the QFT was implemented recursively. In this example, the implementation is transformed it into an iterative implementation in order to make it easier to transform it into its controlled version.

### Example Quantum Fourier Transform Implementation

| | |
|---|---|
| 11 | operation QFTNormal(qs : LittleEndian) : Unit is Adj + Ctl { |
| 12 | body (...) { |
| 13 | let n = Length(qs!); |
| 14 | for (i in 0 .. n − 1) { |
| 15 | H((qs!)[n − i − 1]); |
| [symbol] | if (i != n − 1) { |
| [symbol] | for (j in 0 .. n − i − 2) { |
| [symbol] | Controlled R1Frac([(qs!)[j]], (i, n − 1 − i − j, ( |
| | qs!)[n − i − 1])); |
| [symbol] | } |
| 20 | } |
| 21 | } |
| 22 | for (i in 0 .. (n / 2) − 1) { |
| 23 | // SWAP((qs!)[i], (qs!)[n − 1 − i]), |
| 24 | CNOT((qs!)[i], (qs!)[n − 1 − i]); |
| 25 | CNOT((qs!)[n − 1 − i], (qs!)[i]); |
| 26 | CNOT((qs!)[i], (qs!) [n − 1 − i]); |
| 27 | } |
| 28 | } |

[symbol]

indicates data missing or illegible when filed

In some embodiments, operations may be decomposed into rotations and controlled rotations. Additionally, the depth of the overall circuit may be estimated by evaluating the function from Equation 1, which is roughly given by

Depth≈18mn+2 (3)

for a modulus q=4 and where A is an m×n matrix. In this example estimate, it is assumed that none of the rotations or controlled rotations can be parallelized. Moreover, the real depth also depends on the sparsity of the matrix A, so this expression for the depth can be thought of as an extreme upper bound on the true depth. Furthermore, this implementation utilizes

#Qubits=1+m log q+n log q (4)

where, again, q is the modulus and A is m x n. For a concrete example, consider q=4, n=3, m=6, which results in a depth of 326 and 19 qubits.

The disclosed embodiments include an analysis of Hellinger Overlap between distributions. In some embodiments the function from Equation 1 is only approximately two-to-one. This can be seen by fixing b:

g₀(x)=Ax+e(mod q), for b=0

g₁(x−s)=Ax+e′+e(mod q), for b=1

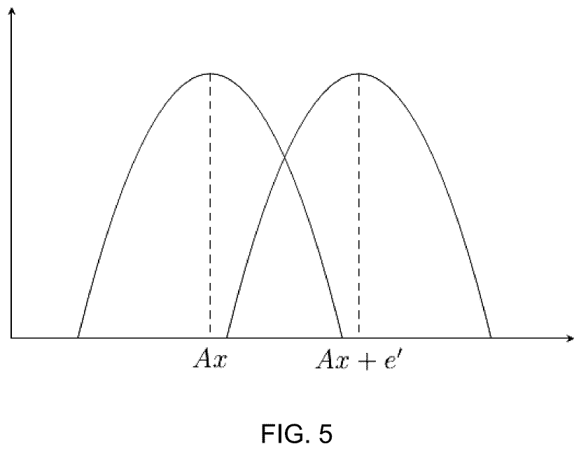

Further, e′ is likely to be a low-weight vector, so Ax+e and Ax+e′+e should be fairly close to equal. This can be seen in FIG. 5, where g₀(x) and g₁(x−s) are interpreted as probability distributions, with variations from their respective centers Ax and Ax+e′ due to the error vector e.

To optimize the performance of the circuit on both simulators and real quantum hardware, certain parameters of the function may be adjusted accordingly to allow for a higher amounts of overlap between the two distributions. Moreover, if there is greater overlap, a valid equation with higher probability may be obtained, increasing the success rate of the implementation. Of these adaptable factors, the most effective is in calibrating the error distribution for e from Equation 1. The amount of overlap for several different distributions for e may be investigated by using the measure known as the Hellinger overlap, which is defined as the following:

$$Overlap = 1 - {H}^{2} ( D , D + e ) = {\sum }_{e ∈ {ℤ}_{q}^{m}} \sqrt{D ( e ) D ( e + {e}^{′} )} \qquad ( 5 )$$

where D is the error distribution for e.

In some embodiments, when evaluating this function, it is possible to evaluate the function over all possible inputs, so e must be in a superposition with amplitudes that reflect the probability distribution it is chosen from. In some embodiments, the this distribution may be defined as a truncated Gaussian distribution. However, to make a superposition over this distribution would add too much overhead to a circuit. Alternatively, distributions may be chosen that are easier to create “quantumly” but also allow for low-weight errors to be chosen with higher probability. Three different types of distributions may be used: uniform, binomial, and multinomial.

Specifically, the uniform distribution is over all e vectors that have an L1 norm bounded by a certain chosen threshold. All other e vectors occur with probability 0. Then, for the binomial case, each entry in the e vector may be considered independently. For each entry, a non-zero entry with probability p or 0 with probability 1−p may be chosen. Moreover, when choosing the non-zero entries, each is chosen uniformly at random from the possible q−1 options. Finally, the multinomial case is a generalized case of the binomial distribution, where each nonzero entry of the e vector is now chosen from the possible q−1 options with different probabilities depending on its absolute value. Furthermore, a multinomial distribution where small errors were more likely than large errors to more closely reflect the truncated Gaussian may be provided.

For each of these distributions, the Hellinger overlap may be calculated numerically and plotted to the L1 norm of the shift vector e′ against this overlap while varying the parameters of the distributions. Ideally, for low weight shifts e′, a very high overlap (close to 1) may be provided, while for high weight shifts, overlap close to 0 may be provided. Additionally, calculations for the case of q=4 may be provided which allows the use of larger LWE instances in the construction of the NTCF function.

Uniform distributions may be defined as

$${D}_{u} ( e , threshold ) = \{ \begin{matrix}0 & if ‖ e ‖ > threshold \\ \frac{1}{\begin{matrix}number of possible errors \\ s . t . ‖ e ‖ \leq threshold\end{matrix}} & if ‖ e ‖ \leq threshold\end{matrix}$$

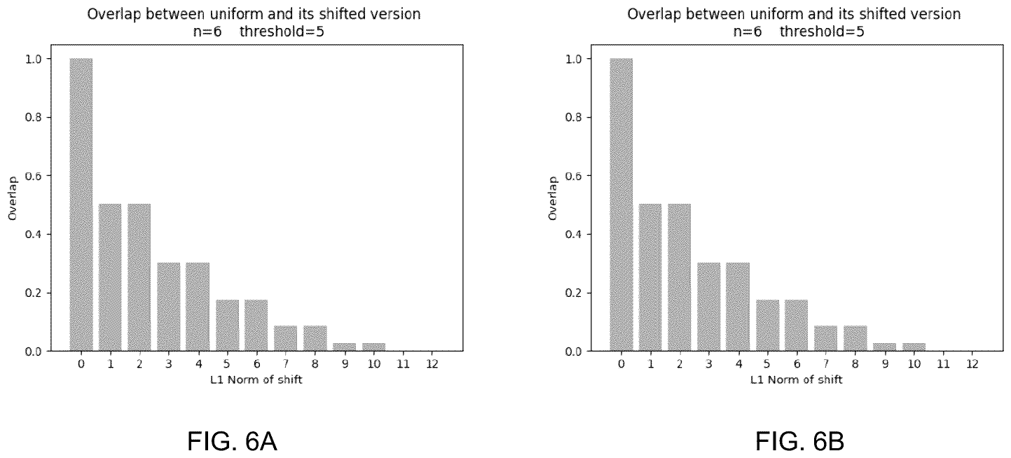

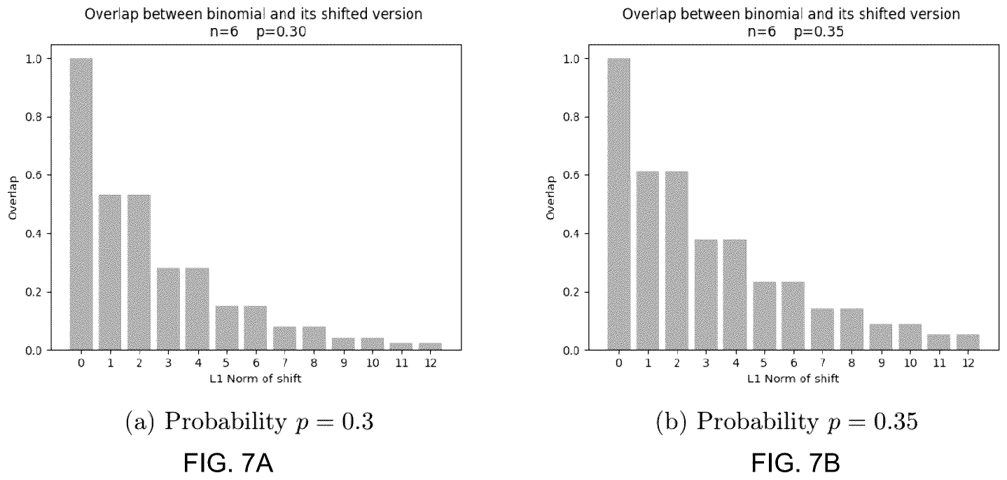

Out of different thresholds from 0 to 12, the results for thresholds of 5 (FIG. 6A) and 6 (FIG. 7B) seemed the most promising. As shown in the uniform distribution plots in FIGS. 6A and 6B, the amount of overlap for shifts of norm 1 or 2 were not as high as was necessary. In some embodiments, these small shifts of 1 or 2 should have overlap significantly higher than 0.5.

FIGS. 7A and 7B depict plots for binomial distribution. In this example, the binomial distribution plots illustrate for when p=0.3 (FIG. 7A) and p=0.35 (FIG. 7B). The results are better than the uniform case as the overlap is lower for higher shifts. Also, a superposition may be created mimicking this distribution using controlled-Y rotations. Each entry in the error state e can be expressed as the superposition below for the binomial distribution.

$${e}_{i} = \sqrt{1 - p} \vert 00 〉 + \sqrt{\frac{p}{3}} \vert 01 〉 + \sqrt{\frac{p}{3}} \vert 01 〉 + \sqrt{\frac{p}{3}} \vert 11 〉$$

Further, the multinomial distribution properties resembled the truncated Gaussian most closely. In particular, multinomial distributions, such that +1 and +3 errors, had a factor f times higher probability of occurring than +2. Viewing +3 as the equivalent of −1 modulo 4, it is seen that +3 is a low-weight error which is wanted with higher probability. Also, in order to make shifts of the same norm have equal overlap, this factor can be fixed depending on p to be

$$f = \frac{( 2 - 2 p ) \pm \sqrt{4 - 4 p}}{2 p}$$

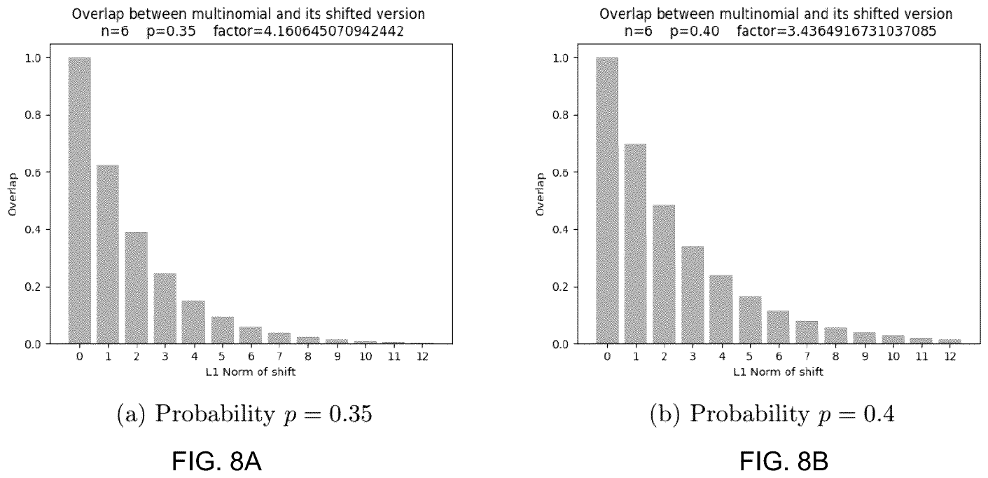

Using this factor, the overlap may be calculated between the original multinomial distribution and one shifted distribution, shifted by e′, as seen in the plots FIGS. 8A and 8B. The multinomial distribution plots FIGS. 8A and 8B show overlap significantly less for higher norm shifts e′ and also high overlap for low norm shifts. Furthermore, a superposition resembling this distribution can be created very similarly to the binomial but with an extra parameter of the factor f.

$${e}_{i} = \sqrt{1 - p} \vert 00 〉 + \sqrt{\frac{fp}{2 f + 1}} \vert 01 〉 + \sqrt{\frac{p}{2 f + 1}} \vert 01 〉 + \sqrt{\frac{fp}{2 f + 1}} \vert 11 〉$$

Performance of each of these distributions may be assessed by evaluating the NTCF function in superposition with each respective distribution for the e register. Following this evaluation, superposition over preimages in the first register may be obtained and checked for an expected outcome. In particular, it is expected that there would be mainly two terms in superposition with amplitudes close to 1/(√2). The fidelity of the superposition may be quite low with all three approaches. This may be largely due to the small instances that were considered in order to fit everything in around 15 qubits.

Given the results from the previous section, an alternative approach regarding claw-free functions based on rounding or truncation may be implemented. Such functions may be defined as

g(b,x)=└Ax+b·(As+e′)┐ (6)
where [·] is specified to be a rounding function that truncates ‘many’ of the least significant bits of the operand. In other words, only take the most significant bits of the number being rounded. Also, in Equation 6, all operations are done modulo q. In some embodiments this function may be viewed as utilizing rounding to create the properties needed, rather than adding in extra noise, as was done before by adding e.

In some embodiments, a rounding scheme may be used and applied to the q=4 and q=8 cases. In this example, the rounding scheme is such that the q elements in Z_{q}, i.e. {0, 1, . . . , q−2, q−1}, are separated into k separate “bins.” Then, for a vector x, each of its components are then rounded to the index of the bin that the component is in. Further, if q, k are powers of two, this is just taking the log k most significant bits of each entry of x, as described in the NTCF function.

Furthermore, upon testing of the implementation utilizing this rounding scheme for k=2 (i.e. just taking the most significant bit), two preimages may be obtained in superposition with 100% probability. Also, as a different test for success, a valid equation may be obtained 100% of the time. Moreover, this implementation utilizes

#Qubits=1+n log q+m log q+m (7)

This provides an increase by m qubits from the previous approach, where the number of qubits is given by Equation 4. However, there are several ways to decrease this number.

Different methods may be provided for reducing qubit usage and depth. Additionally, rough worst-case depth estimates to compare the strategies are provided. Each approach may have its own trade-offs in terms of success as well.

In a first example, a workspace ancilla register may be implemented. In this example, a significant reduction of qubit usage is provided to utilize a workspace register. However, before detailing this approach, a review of an unoptimized technique for comparison is provided. Recall that the initial implementation for the rounding idea used 1+n log q+m log q+m qubits. In order to evaluate the function from Equation 6, there are four quantum registers. The first two together are known as the preimage register, as they store the equal superposition of b, x, i.e. the inputs to the function. The third register then stores the result of evaluating the function prior to rounding, i.e. Ax+b·(As+e′). Finally, the fourth register stores the rounded result, which is simply a vector whose entries are the most significant bit of each entry in the vector Ax+b·(As+e′). These registers are summarized in the expression below.

|b [symbol] |x [symbol] |Ax+b·(As+e′) [symbol] |└Ax+b·(As+e′)┐ [symbol] (8)

Thus, because b is a single bit and x is an n-dimensional vector modulo q, they use one qubit and n log q qubits, respectively. Furthermore, Ax+b·(As+e′) is an m-dimensional vector modulo q, hence corresponding to m log q qubits. Finally, the rounded result is a binary vector where the most significant bits are taken, leading to m additional qubits, in total adding to the number from Equation 7.

In order to reduce qubit usage, each entry in the rounded result vector only depends on one entry from the vector Ax+b·(As+e′). It is not needed to compute Ax+b·(As+e′) all at once, but compute one entry, copy the most significant bit into the result register, then repeat for each entry. This is what is meant mean to utilize a workspace register, where the ancillas are used to calculate each entry of Ax+b·(As+e′) one at a time act as a workspace to do intermediary computations. Furthermore, by computing one entry at a time, this utilizes only log q qubits as opposed to the previous m log q, for a total of

#Qubits=1+n log q+log q+m

This provides a significant decrease in qubit usage. As a concrete example, consider the case of n=2, m=6, q=8. With the original implementation, 31 qubits would be used, while with this version would only use 19. Reusing these ancilla qubits requires to reset them after computing each entry of Ax+b·(As+e′), which roughly doubles the depth. However, because a 100% success rate is obtained with this modification, an increase in error can be afforded. Furthermore, it is found that the number of qubits is generally more restrictive than the depth, as a larger number of qubits can lead to more noisy operations as well.

In another alternative embodiment, a minor adjustment may be made in regards to this was to save one extra qubit from the result register. When calculating the last entry of Ax+b·(As+e′), take the rounded result directly from the ancilla register, rather than copying it into a new qubit since it is no longer needed to reset the ancilla. Thus, the final qubit usage for this optimization is

#Qubits=n log q+log q+m (8)

This small adjustment also reduces depth slightly, as the ancilla is not reset. Furthermore, the success rate is maintained at 100%. A rough, worst-case depth estimate is given by

Depth≈3+2mn(log q)²+6m log q−m (9)

In another embodiment, another adjustment for reducing qubit usage can be used in addition to the one detailed previously. This technique may be referred to as phase encoding. The approach is based off of quantum random access codes (QRAC). Here, the idea is to encode k classical bits into one qubit and by measuring in a certain basis. In this example, any of the k classical bits may be recovered with high probability.

Similarly, in this phase encoding technique, several of the rounded result bits may be encoded into the phase of one qubit, which is referred to as a phase qubit. However, because these phase qubits are not orthogonal, the success rate for using fewer qubits may be sacrificed. Furthermore, the more phase qubits there are, the closer to orthogonal, and hence more accurate, the whole state will be. Thus, there is a balance between reducing the number of qubits and the success rate. The specific numerics of phase encoding and the success rate are discussed here. while here we discuss the circuits required to encode two or three bits into one phase qubit.

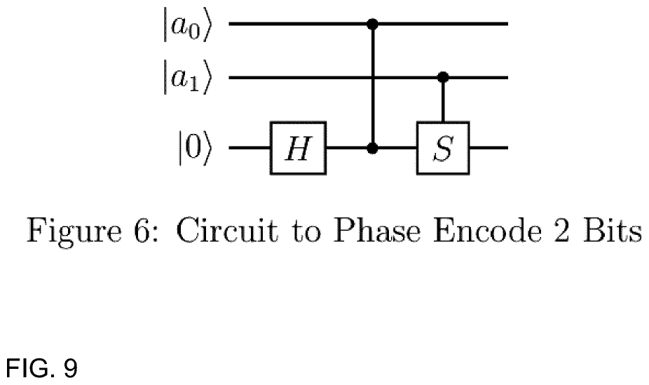

In order to encode two bits into one phase qubit, the circuit depicted in FIG. 9 may be used. Note that a₀, a₁∈{0, 1} are the bits to encode, where |a₀>, |a1> are the qubits that store the respective bits. This circuit utilizes π/2 Z rotations in order to encode these bits into the phase qubit represented by the bottom wire. Furthermore, this can also be described by the following transformation:

$$\begin{matrix}\vert 00 〉 \to \vert + 〉 \\ \vert 01 〉 \to \vert {+}_{π / 2} 〉 \\ \vert 10 〉 \to \vert {+}_{π} 〉 \\ \vert 11 〉 \to \vert {+}_{3 π / 2} 〉\end{matrix}$$

$$where$$

$$\vert {+}_{θ} 〉 = \frac{1}{\sqrt{2}} ( \vert 0 〉 + {e}^{i θ} \vert 1 〉 )$$

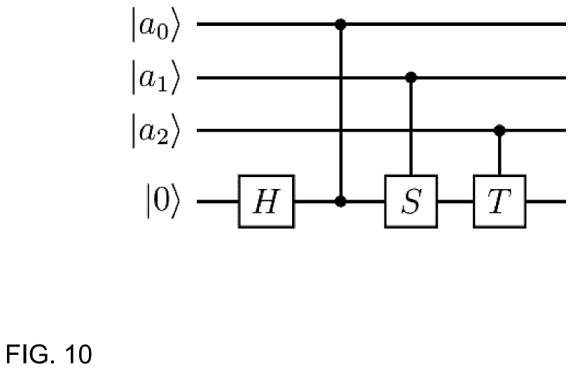

Similarly, as shown in FIG. 10, three bits may be encoded into one phase qubit. This circuit utilizes π/4 Z rotations rather than π/2 in order to encode more bits into a single phase qubit. Furthermore, this can be described by the transformation:

$$\begin{matrix}\vert 000 〉 \to \vert + 〉 \\ \vert 001 〉 \to \vert {+}_{π / 4} 〉 \\ ⋮ \\ \vert 111 〉 \to \vert {+}_{7 π / 4} 〉\end{matrix}$$

This strategy for reducing qubit usage does not affect the depth of the circuit, so this is still given by the expression from Equation 9. However, as discussed previously, it does affect the accuracy of the results. Moreover, the qubit usage varies depending on how many bits are encoded into one phase qubit. Let c be the number of bits encoded. Then, the number of qubits required is given by the following expression

#Qubits=1+n log q+log q+[m/c] (10)

In yet another strategy, a direct computation of result in phase using QRAC is provided. This significant strategy is similar to the previous one, in that it is also based off of quantum random access codes (QRAC). Recall that the idea is to encode k classical bits into one qubit and by measuring in a certain basis, recover any of the k classical bits with high probability. Here, both of the approaches utilize QRAC to reduce qubit usage, but differ in what they encode. In contrast to phase encoding, here the computing result Ax+b·(As+e′) directly in phase then performing a special measurement to retrieve the most significant bit. Recall that in phase encoding, computing Ax+b·(As+e′) in the computational basis and then encoding the rounded results in phase.

To further illustrate the specifics of the idea, have m phase qubits, similar to in phase encoding. However, rather than using the workspace register, directly compute each entry of Ax+b·(As+e′) into the phases of each of the corresponding phase qubits. For instance, say a is the i-th row of A and y=As+e′, where yᵢ is the i-th entry of y. Then, after the computation, the phase qubit will be in the state

$$\vert {+}_{θ} 〉 , θ = \frac{π}{4} \cdot ( 〈 a , x 〉 + b \cdot {y}_{i} )$$

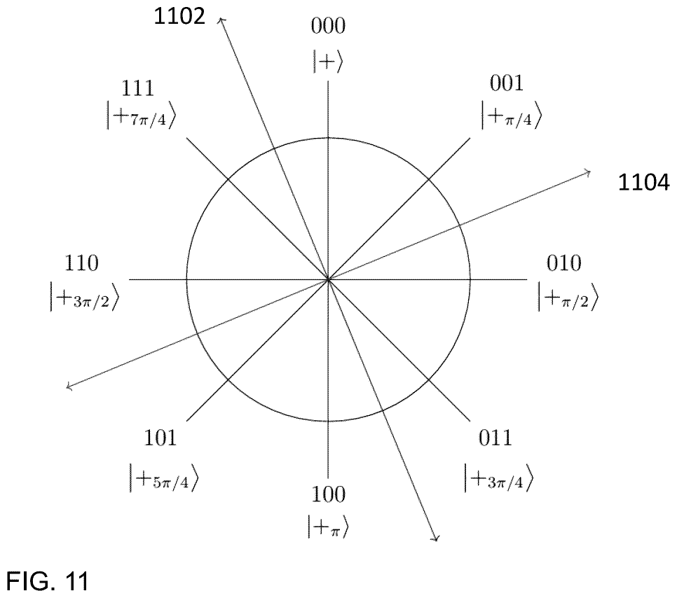

which can be done using controlled Z rotations. Moreover, because A, y both have entries modulo q, then there can only be q total possible |+0> states. For this approach, only consider q=8 to optimize performance, so for this case, there are eight possible |+θ> states. These states may be visualized in the XY plane of the Bloch sphere, as shown in FIG. 11.

In view of FIG. 11, the four states with most significant bit 0 are on the right side of axis 1102, while the other four states with most significant bit 1 are on the left side of axis 1102. Thus, a measurement along the axis 1104, should get the correct most significant bit with high probability. This axis 1104 corresponds to measuring in the basis:

{|+3π/8 [symbol] ,|−3π/8 [symbol] }

In some embodiments, the probability may be analyzed with which to obtain the most significant bit. Assuming that there is one of the four states with most significant bit of 0, then want to find the probability that measure a 0. Without loss of generality, assume that the four states occur with equal probability. Then, referring to FIG. 11 that |+π/4>, |+π/2> form an angle of π/8 with the 0 outcome (axis 1104). Similarly, |+>, |+3π/4> form an angle of 3π/8 with the 0 outcome. Recall that the probability of an outcome is given by the cosine squared of half of the angle between the two states on the Bloch sphere. Thus, in this example, the probability of obtaining 0 if one of the states with most significant bit 0 is

$$\frac{1}{2} ( {cos}^{2} ( \frac{3 π}{16} ) + {cos}^{2} ( \frac{π}{16} ) ) \approx 0.82 \qquad ( 11 )$$

Furthermore, it can be shown that this is approximately the optimal success probability with which to encode and recover k=3 bits. In order to see this, consider Nayak's bound which states that if a QRAC encodes m classical bits into n qubits to recover each of the m classical bits with probability p, then it must be that

n≥(1−H(p))m
where H(p) is the binary entropy function

H(p)=−p log₂(p)−(1−p) log₂(1−p)

In this example, 3 classical bits may be encoded into 1 qubit. As seen in Equation 11, this may be done so with probability 0.82. Thus, calculating the binary entropy function:

H(0.82)≈0.68

Furthermore, using Nayak's bound, it is known that

⅓≥1−H(p)≈0.32

Hence, it can be seen that the probability with which to recover the most significant bit is close to optimal by Nayak's bound. Overall, this approach is a large deviation from the original implementation, but with a significant reduction in depth as well as a small decrease in qubit usage. Because of computing Ax+b·(As+e′) in phase and measuring to obtain the rounded result, the ancilla register is no longer need. Thus, qubit usage decreases by log q for a total of

#Qubits=1+n log q+m (12)

Furthermore, the circuit for performing the computation in phase is much simpler than in the previous approaches. As a rough, worst-case depth estimate:

Depth=4+mn log q+m (13)

However, in exchange for these improvements, the success rate also decreases significantly. Despite the most significant bit being recovered with high probability, even if one is wrong, this will cause the entire equation to be invalid during tests.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

Those of skill in the art will appreciate that the herein described apparatuses and methods are susceptible to various modifications and alternative constructions. There is no intention to limit the scope of the invention to the specific constructions described herein. Rather, the herein described apparatuses and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A quantum computing device, comprising:
at least one processor and a memory configured to implement a function to reduce qubit usage;
a workplace register including:
a first and second register configured to store equal superposition of one or more inputs to the function;
a third register configured to store a result of an evaluation of the function prior to rounding; and
a fourth register configured to store a rounded result.

2. The computing device of claim 1, wherein the first, second, third and fourth registers are quantum registers.

3. The computing device of claim 2, wherein the first, second, third and fourth quantum registers are summarized by:

|b [symbol] |x [symbol] |Ax+b·(As+e′) [symbol] |└Ax+b·(Ax+e′)┐ [symbol]
where b is a single bit and x is an n-dimensional vector modulo q.

4. The computing device of claim 3, wherein b uses one qubit.

5. The computing device of claim 3, wherein x uses n log q qubits.

6. The computing device of claim 3, wherein Ax+b·(As+e′) is an m-dimensional vector modulo q corresponding to m log q qubits.

7. The computing device of claim 3, wherein the rounded result is a binary vector leading to m additional qubits.

8. The computing device of claim 3, wherein the function, when implemented, utilizes the workplace register.

9. The computing device of claim 8, wherein implementation of function optimizes qubit usage and includes:
calculate each entry of Ax+b·(As+e′); and
copy the most significant bit into the rounded result register.

10. The computing device of claim 9, for the last entry in the rounded result, take the rounded result directly from the register.

11. The computing device of claim 10, wherein qubit usage optimization is #Qubits=n log q+log q+m.

12. A system for implementing remote-state preparation on a noisy-intermediate size quantum (NISQ) device:
a NISQ server having at least one memory and a processor configured to verify the preparation of quantum states on the NISQ device;
the NISQ configured to implement a function to reduce qubit usage using a workplace register, the workplace register including:
a first and second register configured to store equal superposition of one or more inputs to the function;
a third register configured to store a result of an evaluation of the function prior to rounding; and
a fourth register configured to store a rounded result.

13. The system of claim 12, wherein the first, second, third and fourth registers are quantum registers.

14. The system of claim 13, wherein the first, second, third and fourth quantum registers are summarized by:

|b [symbol] |x [symbol] |Ax+b·(As+e′) [symbol] |└Ax+b·(As+e′)┐ [symbol]
where b is a single bit and x is an n-dimensional vector modulo q.

15. The system of claim 14, wherein b uses one qubit.

16. The system of claim 14, wherein x uses n log q qubits.

17. The system of claim 14, wherein Ax+b·(As+e′) is an m-dimensional vector modulo q corresponding to m log q qubits.

18. The system of claim 14, wherein the rounded result is a binary vector leading to m additional qubits.

19. The system of claim 18, wherein implementation of function optimizes qubit usage and includes:
calculate each entry of Ax+b·(As+e′); and
copy the most significant bit into the rounded result register.

20. The system of claim 19, for the last entry in the rounded result, take the rounded result directly from the register.
